(19) United States
(12) Patent Application Publication
(10) Pub. No.: US 2024/0251774 A1
(43) Pub. Date: Aug. 1, 2024

(54) REMOTE MONITORING DEVICE FOR ANIMALS OR INSECTS

(71) Applicant: PESTRAC MONITORING SYSTEMS AUSTRALIA PTY LTD, KOGARAH, NSW (AU)

(72) Inventor: Jeffery Wainohu, Bass Hill, NSW (AU)

(21) Appl. No.: 18/560,620

(22) PCT Filed: May 24, 2022
(86) PCT No.: PCT/AU2022/050500

§ 371 Date: Nov. 13, 2023

(30) Foreign Application Priority Data
May 24, 2021 (AU) 2021901550

(51) Int. Cl. A01M 1/02; A01M 1/14

(52) U.S. Cl. CPC A01M 1/026; A01M 1/14

(57) ABSTRACT

The present disclosure relates to a remote monitoring device for animals or insects. An example remote monitoring device may comprise: a receptacle or platform for receiving a monitored load, the receptacle or platform configured with one or more load cells for measuring the monitored load; a transmitter; and a microcontroller configured with a processor; wherein the processor is programmed to: measure, with the one or more load cells, an initial mass of the monitored load; periodically measure, with the one or more load cells, a current mass of the monitored load; and transmit, with the transmitter, a notification signal once a predetermined mass difference between the initial mass and the current mass is reached. An example method for remote monitoring of animals or insects is also disclosed.

### TECHNICAL FIELD

The present disclosure relates to a remote monitoring device for animals or insects. In particular, to a remote monitoring device for the remote monitoring of animals or insects to maintain general welfare or control population size.

### BACKGROUND

The remote monitoring of food consumption of animals or insects enables observers/end users to determine various characteristics of the local environment, as well as the general status of the animals or insects. This information can be used by observers/end users to control the general welfare of beneficial animals or insects and control the population size of detrimental pest animals or insects.

Current methods of remote monitoring of food consumption involve the use of technology and methods that cater to specific breeds/species of animals or insects. Typically, this involves monitoring animals or insects which have been tagged with RFID chips to monitor their feed patterns. Due to this design, it is difficult and time consuming to adapt these technologies and methods to other animals or insects, as their feeding behaviour is likely to be substantially different to the originally targeted animal or insect.

Current methods of remote monitoring of pests are limited to traps and toxic baits which are deployed to capture of kill pests. These pest bait stations typically have housings designs to attract pests into the bait station, to consume bait set out for the pests. These pests are subsequently poisoned, trapped, or both. These pest bait stations may subsequently monitor whether a pest has been trapped or sufficient volume of deceased pests has accumulated prior to transmitting a signal for observers/end users to retrieve or dispose of the pests. Additionally, it is difficult and time consuming for observers/end users to monitor bait levels inside each pest bat station, as they must physical be present at the pest bait station to manually inspect them. Furthermore, observers/end users are unable to retrieve bait consumption data that is essential for the determination of environmental factors and general status of the pests.

Any discussion of documents, acts, materials, devices, articles or the like which have been included in the present specification is not to be taken as an admission that any or all of these matters form part of the prior art base or were common general knowledge in the field relevant of the present disclosure as it existed before the priority date of each of the appended claims.

### SUMMARY

There is provided a monitoring device for the remote monitoring of animal or insect feeding pattern. In particular, the feed patterns of livestock, pets, and pests. This ensure that livestock and pets can be monitored to control their food intake and welfare, while pests can be monitored to control their infestation levels and attend to their capture/disposal.

According to a first aspect, there is provided a remote monitoring device for one or more animals or insects, comprising:
a receptacle or platform for receiving a monitored load, the receptacle or platform is configured with one or more load cells for measuring the monitored load;
a transmitter; and
a microcontroller configured with a processor; wherein the processor is programmed to: measure, with the one or more load cells, an initial mass of the monitored load;
periodically measure, with the one or more load cells, a current mass of the monitored load; and
transmit, with the transmitter, a notification signal once a predetermined mass difference between the initial mass and the current mass is reached.

In an embodiment, the device further comprises a switch configured to enable or disable the one or more load cells.

In an embodiment, the switch is further configured as a manually activated switch.

In an embodiment, the switch is in communication with a sensor, and the switch being further configured to enable or disable the one or more load cells based upon an input from the sensor.

According to a second aspect, there is provided a remote monitoring device for one or more animals or insects, comprising:
a receptacle or platform for receiving a monitored load, the receptacle or platform is configured with one or more load cells for measuring the monitored load;
a switch, in communication with a sensor, configured to enable or disable the one or more load cells;
a transmitter; and
a microcontroller configured with a processor; where the processor is programmed to:
activate, with the switch, the one or more load cells when the switch receives a first signal from the sensor;
measure, with the one or more load cells, an initial mass of the monitored load;
deactivate, with the switch, the one or more load cells when the switch
receives a second signal from the sensor;
measure, with the one or more load cells, a current mass of the monitored
load; and
transmit, with the transmitter, a notification signal containing a mass
difference between the initial mass and the current mass.

In an embodiment, the sensor is an audio, motion, optical, thermal, vibration, or video sensor.

In an embodiment, the sensor is a strain gauge or another load cell incorporated in a ramp or platform for supporting the one or more animals.

In an embodiment, the measurable load is an edible substance.

In an embodiment, the measurable load is the one or more animals or insects.

In an embodiment, the receptacle or platform is configured with an adhesive surface for trapping the one or more insects and or animals.

In an embodiment, the device further comprises a housing for the receptacle or platform, wherein the housing comprises at least one opening for enabling access to the receptacle or platform for the one or more animals or insects.

In an embodiment, each of the at least one opening has a deployable barrier for blocking the opening.

In an embodiment, each deployable barrier is deployed upon receiving an input from a trigger sensor.

In an embodiment, each deployable barrier is deployed when the processor transmits the notification signal.

In an embodiment, the device further comprises a repellent for repelling the one or more animals or insects, wherein the repellent is configured to activate when the processor transmits the notification signal.

According to a third aspect, there is provided a method of remote monitoring animals or insects, comprising:
attracting one or more animals or insects to a receptacle or platform, configured with one or more load cells, for measuring a monitored load;
measuring, with the one or more load cells, an initial mass of the monitored load; periodically measuring, with the one or more load cells, a current mass of the
monitored load; and
transmitting, with a transmitter, a notification signal when a predetermined mass difference between the initial mass and the current mass is reached.

In an embodiment, the method further comprises repelling, with a repellent, the one or more animals or insects from the receptacle or platform.

According to a fourth aspect, there is provided a method of remote monitoring animals or insects, comprising:
attracting one or more animals or insects to a receptacle or platform, configured with one or more load cells, for measuring a monitored load, and a switch in communication with the one or more load cells for activating or deactivating the load cell;
activating, with a switch, the one or more load cells;
measuring, with the one or more load cells, an initial mass of the monitored load; deactivating, with the switch, the one or more load cells after measuring a current
mass of the monitored load; and
transmitting, with a transmitter, a notification signal containing a mass difference between the initial mass and the current mass.

In an embodiment, the switch, in communication with a sensor, is activated by the one or more animals or insects triggering the sensor.

According to a fifth aspect, there is provided a method of remote monitoring animals or insects, comprising:
attracting one or more animals or insects to a receptacle or platform, configured with one or more load cells, for measuring a monitored load, the receptacle or platform being located within a housing having one or more openings, each opening having a deployable barrier;
measuring, with the one or more load cells, an initial mass of the monitored load; periodically measuring, with the one or more load cells, a current mass of the
monitored load;
transmitting, with a transmitter, a notification signal when a predetermined mass difference between the initial mass and the current mass is reached; and
deploying each deployable barrier to cover the one or more openings.

### BRIEF DESCRIPTION OF DRAWINGS

A non-limiting example will now be described with reference to the following drawings:

FIG. 1 is an exploded view of a monitoring device for rodents.

FIG. 2 is a cross sectional view of the monitoring device for rodents.

FIG. 3 is an exploded view of a monitoring device for termites.

FIG. 4 is a cross sectional view of the monitoring device for termites.

FIG. 5 is an exploded view of a monitoring device for flying insects.

FIG. 6 is a cross sectional view of the monitoring device for flying insects.

FIG. 7 is an exploded view of a monitoring device for feral animals.

FIG. 8 is a cross sectional view of the monitoring device for feral animals.

FIG. 9 is an exploded view of a monitoring device for cockroaches.

FIG. 10 is a cross sectional view of the monitoring device for cockroaches.

FIG. 11 illustrates a flow diagram of a first method for remote monitoring of animals or insects.

FIG. 12 illustrates a flow diagram of a second method for remote monitoring of animals or insects.

FIG. 13 illustrates a flow diagram of a third method for remote monitoring of animals or insects.

### DESCRIPTION OF EMBODIMENTS

### General Terms

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### Monitoring Device

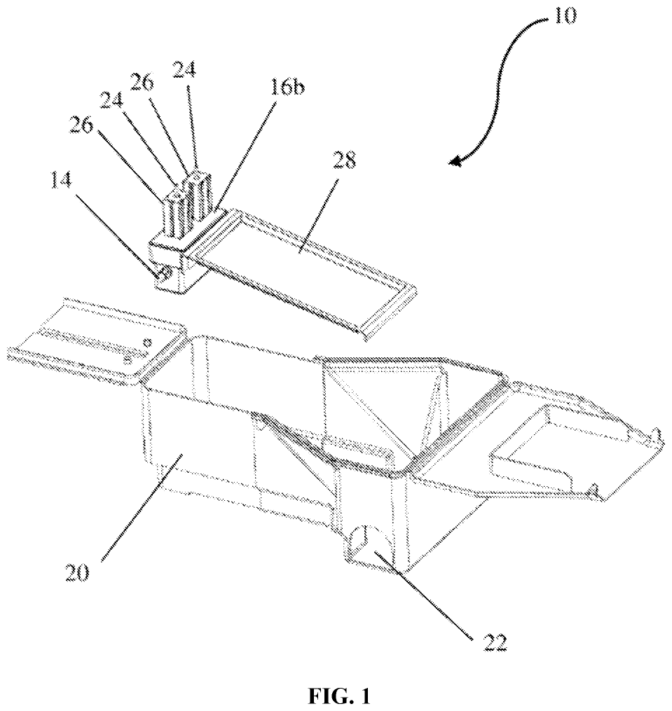

The present disclosure comprises a remote monitoring device for animals or insects as shown in several embodiments in FIG. 1 to FIG. 8.

The remote monitoring device 10 of the present disclosure is comprised of a microcontroller 12, a transmitter 14, and a receptacle 16a for holding a monitored load or a platform 16b for carrying the monitored load. The receptacle/platform 16a, 16b is configured with one or more load cells 18, preferably in the form of strain gauge load cells, to enable the accurate measurement of a mass of the monitored load by the microcontroller 12. The microcontroller 12 is programmed to measure an initial mass of the monitored load and a current mass of the monitored load. Additionally, the microcontroller 12 is programmed to calculate a mass difference value between the initial mass and the current mass of the monitored load. Furthermore, the microcontroller 12 is programmed to transmit a notification signal and the mass difference value, using the transmitter 14, to an external device once a predetermined event occurs. The external device may be a remote server, such as a cloud server, or other remote computer device. Once the notification signal and mass difference value are received by the external device, the external device may transmit notification to a smart device, owned/operated by an observer, informing the observer of the status of the remote monitoring device 10. The observer may subsequently act upon this notification to interact with the remote monitoring device 10, such as replenishing consumables found in the remote monitoring device 10 or retrieving the remote monitoring device 10. The external device may store the mass difference value for data analytics related to feed behaviour and general welfare of animals or insects, as well as environmental characteristics such as population levels and food availability.

The monitored load that is measured by the microcontroller 12 is dependent upon the target animals or insects. In a preferred embodiment, the monitored load for the remote monitoring device 10, targeting animals, is an edible substance such as feed or poisoned bait. In this embodiment, the initial mass of the monitored load is the mass of the edible substance prior to being consumed by animals. Subsequently, the current mass of the monitored load is the mass of the edible substance as measured by the load cell 18 after the animal has commenced feeding. In another preferred embodiment, the monitored load for the remote monitoring device 10, targeting pests are the pests themselves. In this embodiment, the receptacle/platform 16a, 16b is configured with an adhesive surface for trapping one or more animals or insects to ensure a consistent mass value. The initial mass of the monitored load is negligible, as edible material is of minute quantity or a lure is used to attract the animals or insects to the receptacle/platform 16a, 16b. Subsequently, the current mass of the monitored load is the mass of the pests that have been collected on the receptacle/platform 16a, 16b.

It would be appreciated by persons skilled in the art that the use of either the receptacle 16a or the platform 16b is based upon what the monitored load is comprised of. For example, a receptacle 16a would be used if the edible substance is loose material such as kibble, hay, granular bait, and pastes/liquids, whereas a platform would be used if the edible substance is a solid block of bait that is anchored to the platform with a feeding pole or bait that is impregnated into an adhesive strip for trapping pests.

The microcontroller 12 comprises at least one processor, computer memory and a data storage. The microcontroller 12 further comprises communication interfaces to communicate with ancillary devices, such as sensors for receiving external input and a communication module for transmitting and/or receiving signals, such as the transmitter 14, over a communication network, such as the internet, Bluetooth or WLAN. The at least one processor of the microcontroller 12 is configured to execute program code stored in the computer memory, causing the remote monitoring device to function according to a set of instructions as described in the methods.

The one or more load cells 18 may be adapted to communicate with a switch (not shown) to activate or deactivate the one or more load cells. In an embodiment, the switch may be in the form of a manual switch, such as a push-button switch or toggle switch, that must be intentionally handled by the observer/end user. In a preferred embodiment, the switch may be in the form of a relay switch which are triggered based upon receiving a signal. The signal may be from the microcontroller 12 for when a predetermined event occurs or from the ancillary sensor, such as an audio, motion, optical, thermal, vibration, or video sensor, that indicates when the animals or insects have accessed the receptacle/platform 16a, 16b.

The monitored device 10 may be configured with a repellent for repelling the one or more animal or insects. The repellent may be configured activate upon receiving an activation signal from the microcontroller 12. The activation signal may be based upon a predetermined event occurring, such as when a predetermine mass difference value is achieved or when the transmitter has transmitted the notification signal. The repellent may be of any type that is suitable for the targeted animals or insects. In an example, the repellent may be a bright light, or a loud sound use do to drive off animals or insects. In another example, the repellent may be a scent, pheromone, or vibrations that is used to induce fear or disgust in animals or insects. This advantageously restricts the overconsumption of edible substances, such as feed or bait. Additionally, it reduces the chances of secondary poisoning occurring from predators consuming animals or insects which have overconsumed poisoned bait.

The monitored device 10 may be further configured with a housing 20 that substantially encapsulates the receptacle/platform 16a, 16b. The housing 20 may comprise at least one opening 22 for enabling access to the receptacle/platform 16a, 16b for animals or insects. Additionally, the housing 20 may be of sufficient size to encapsulate the animals or insects in addition to the receptacle/platform 16a, 16b.

The opening 22 may be configured with a deployable barrier 24 for blocking the opening 22, thereby advantageously restricting access to the edible substance found on the receptacle/platform 16a, 16b or trapping the animals or insects within the housing 20. In an embodiment, the deployable barrier is in the form of a door that is swung closed using a motor or release spring. In another embodiment, the deployable barrier may be a roller shutter used to cover the opening of a receptacle 16a, denying access to the monitored load for animals.

The monitored device 10 may be further configured with a transceiver instead of the transmitter 14, to enable the reading of wireless identification, such as RFID tags and Bluetooth enabled devices. The microprocessor 12 may be programmed to receive instructions from devices that provide valid wireless identification and allow retrieval of information from the microprocessor 12, such as the initial mass, the current mass, and mass difference values. Additionally, the microprocessor 12 may be programmed to deploy or stow deployable barriers upon receiving valid wireless identification. This advantageously allows animals, such as pets and live stock, which may have collars or tags enabled with RFID chips to provide access to receptacles/platforms 16a, 16b of the remote monitored device 10. Additionally, it allows for the remote monitoring of specific animals, so as to monitor their food consumption rates and determine their general welfare.

### Example—Rodent Remote Monitoring Device

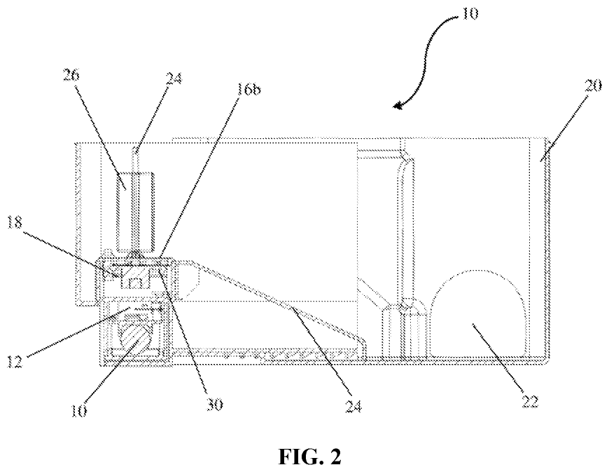

FIGS. 1 and 2 illustrates an example of the remote monitoring device 10 adapted for rodents. The remote monitoring device 10 has a housing 20 configured with an opening 22 for allow rodents access to the platform 16b. The platform 16b is located above an enclosure housing a load cell 18, a microprocessor 12, and a transmitter in the form of a transmission antenna. The platform 16b is further configured with a pair of feeding poles 24 to hold poisoned bait 26 that is considered a monitored load. A switch is in communication with the load cell 18 to activate or deactivate the load cell 18. A sensor in the form of a ramp 28 configured with a strain gauge or additional load cell 30 is in communication with the switch, to detect the presence of a rodent adjacent to the platform 16b that is likely consuming the monitored load of poisoned bait.

As the rodent enters the housing 20, it will ascend the ramp 24 to reach the monitored load of poisoned bait. As the rodent puts its mass on the ramp, it causes the strain gauge or additional load cell to register a change in load, thereby causing the switch to activate the load cell 14. Upon the load cell 14 activating, the microprocessor 12 will instruct the load cell 14 to measure the initial mass of the monitored load. Once the rodent has consumed enough of the monitored load, the rodent will move off the ramp, causing the strain gauge or additional load cell to reset. This causes the switch to send a deactivation signal to deactivate the load cell 14. Prior to deactivating the load cell 14, the microprocessor 12 will instruct the load cell 14 to measure the current mass of the monitored load. Subsequently, the microprocessor 12 will prepare the notification signal to transmit via the transmitter 14 to a cloud server for informing the observer.

In an embodiment, the remote monitoring device 10 may be configured with a repellent in the form of high lumen lights or a shrill siren. This repellent may be activated by the microprocessor 12 upon a predetermined mass difference being reached.

### Example—Termite Remote Monitoring Device

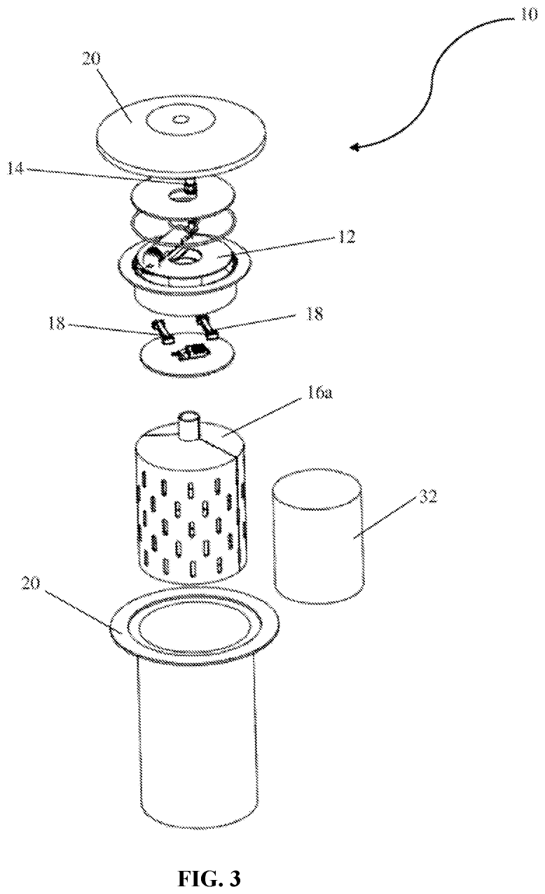

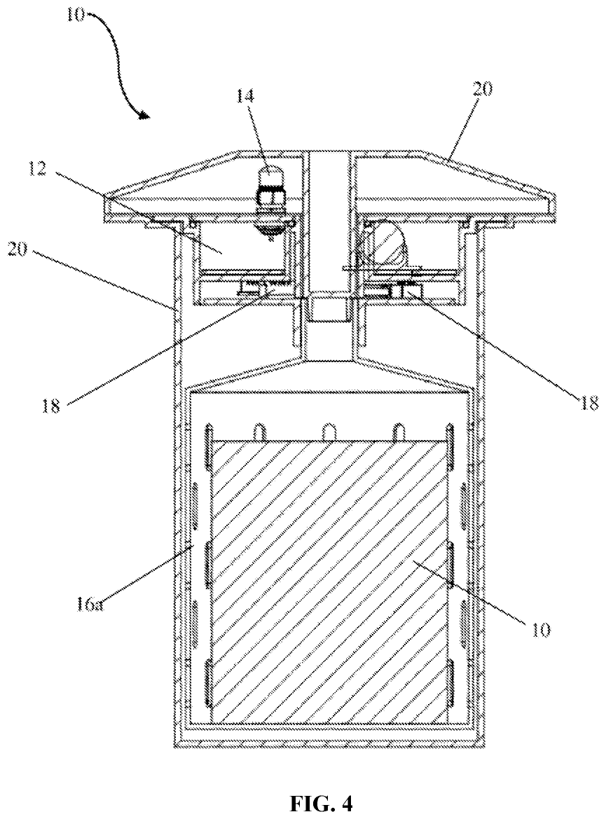

FIGS. 3 and 4 illustrates an example of the remote monitoring device 10 adapted for termites. The remote monitoring device 10 has a housing 20 configured to encapsulate a receptacle 16a in the form of a perforated cage for housing a block of wood 32 that is considered a monitored load. The receptacle 16a is located below an enclosure housing a pair of load cells 18, a microprocessor 12, and a transmitter 14 in the form of a transmission antenna.

As the termites enter the receptacle 16a to consume the monitored load, the microprocessor 12 instructs the pair of load cells 18 to measure an initial mass of the monitored load. The microprocessor 12 subsequently measure, using the pair of load cells 18, a current load in accordance with a predetermined time schedule. Upon each measurement, the microprocessor 12 compares the initial mass with the current mass to determine a mass difference value. If the mass difference value is the same or exceed a predetermined mass difference value, the microprocessor 12 will prepare and transmit a notification signal, via the transmitter 14, to a cloud server for informing the observer/end user. Additionally, it may also transmit a record of the measured masses and associate time stamps for data analytics.

In an embodiment, the housing 20 may include a thermal sensor to detect the presence of termites as they approach the receptacle 16a. This thermal sensor may be used in conjunction with a switch to activate or deactivate the pair of load cells 18.

### Example—Flying Insect Remote Monitoring Device

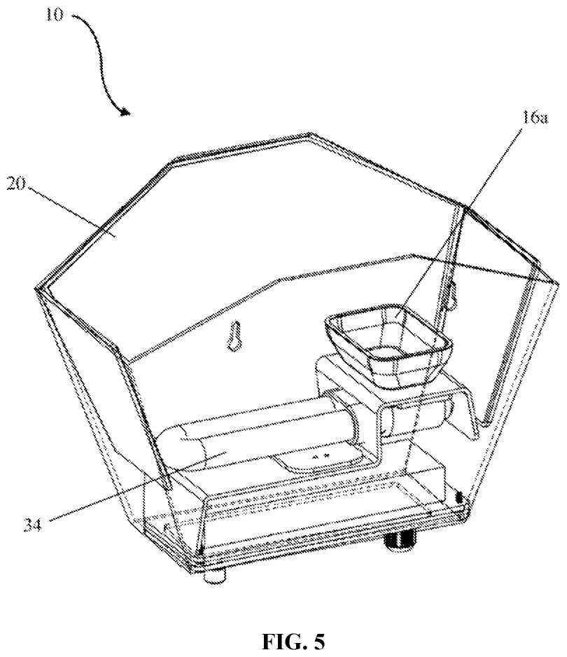

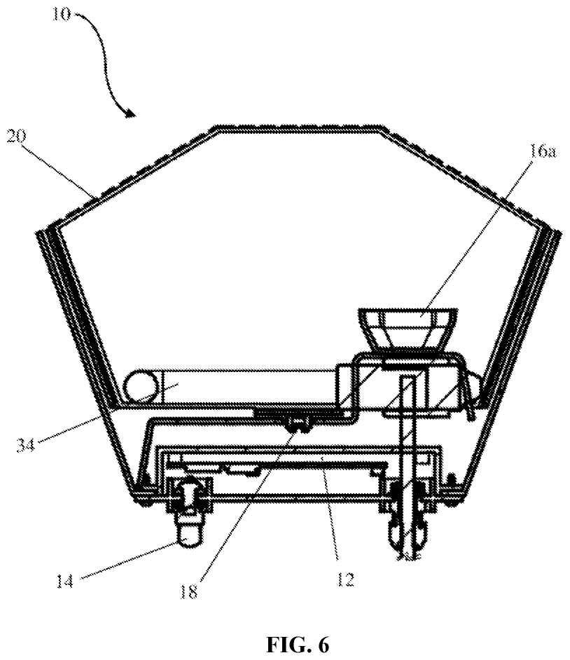

FIGS. 5 and 6 illustrates an example of the remote monitoring device 10 adapted for flying insects. The remote monitoring device 10 has a housing 20 configured to funnel flying insects to a receptacle 16a having tapered side walls. The receptacle 16a is lined with a plurality of adhesive strips impregnated with bait for attracting insects and securing insects in the receptacle 16a. The housing 20 is also configured with a light 34 for attracting and repelling insects to the receptacle 16a. The receptacle 16a is located above an elongated enclosure housing a load cell 18, a microprocessor 12, and a transmitter 14 in the form of a transmission antenna.

When the light 34 for attracting insects is lit, the insects are drawn to the receptacle 16a and the microprocessor 12 measures an initial mass of the empty receptacle 16a. As the insects are drawn to the receptacle 16 and land, they become stuck to the adhesive strips and act as the monitored load. As the number of insects stuck in the receptacle 16a increase, the current mass also increases. Upon the microprocessor 12 determining that a mass difference value is the same or exceeds a predetermined mass difference value, the light 34 will be switched off and cause any loitering insects to be repelled from the receptacle 16a. Additionally, the microprocessor 12 will prepare and transmit a notification signal, via the transmitter, to a could server for informing the observer.

In an embodiment, the housing 22 may include an optical or video sensor for determining the presence of insects. The optical or video sensor may be used in conjunction with a switch to activate or deactivate the cell 18.

### Example—Feral Animal Remote Monitoring Device

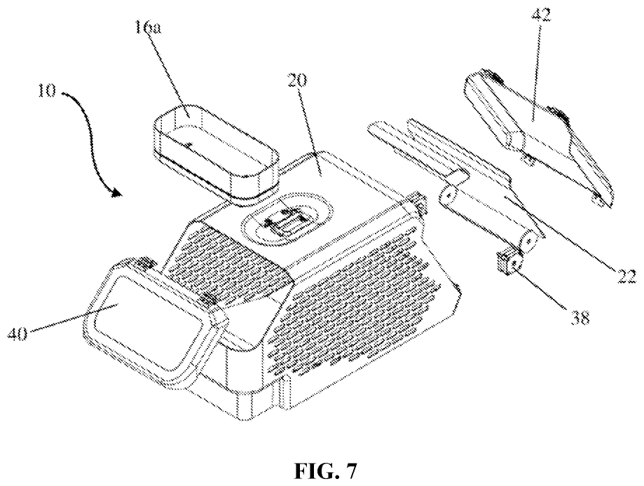

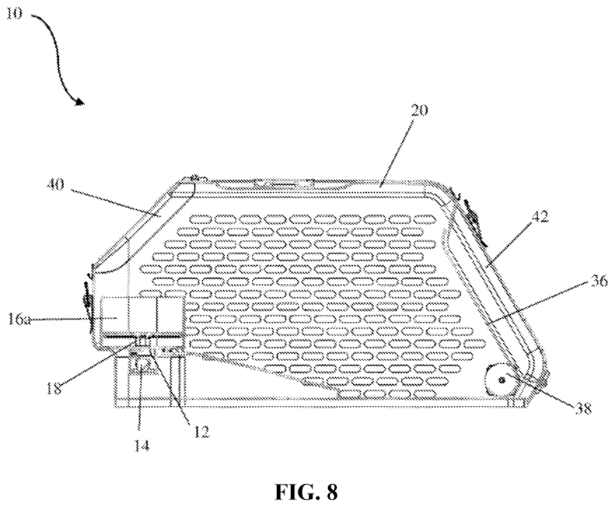

FIGS. 7 and 8 illustrates an example of a remote monitoring device 10 adapted for the capture of feral animals. The remote monitoring device 10 has a housing 20 configured to encapsulate a receptacle 16a and an animal. The housing 20 additionally has an opening 22 with a deployable barrier 36, in the form of a door, for trapping an animal. The deployable barrier 36 is deployed using a motor 38. The receptacle 16a is located above an enclosure housing a pair of load cells 18, a microprocessor 12, and a transmitter 14 in the form of a transmission antenna. Additionally, the housing 20 is configured with a viewing port 40 for the observer/end user to view the trapped animal and a security door 42 overlap the deployable door 36 and provide reinforcement to reduce the chance of the animal escaping confinement.

When the remote monitoring device 10 is initially deployed, the opening 22 is not blocked by the deployable barrier 36. An attractive bait, considered the monitored load, is located on the receptacle 16a and is used to attract a feral animal into the housing 20 so it can feed upon the bait. Prior to the feral animal consuming the bait, the microprocessor 12 instructs the pair of load cells 18 to measure an initial mass of the monitored load. As the feral animal consumes the bait, the microprocessor 12 periodically records a current mass of the monitored mass and calculates a mass difference value. Upon the mass difference value being the same or exceeding a predetermined mass difference value, the microprocessor 12 will cause the deployable barrier 36 to close and securely trap the feral animal within the housing 20. Subsequently, the microprocessor 12 will prepare and transmit a notification signal, via the transmitter 14, to a cloud server for informing the observer/end user. This is advantageous as it allows the observer/end user to monitor feeding habits of feral animals as well as know when to retrieve a captured feral animal.

### Example—Cockroach Remote Monitoring Device

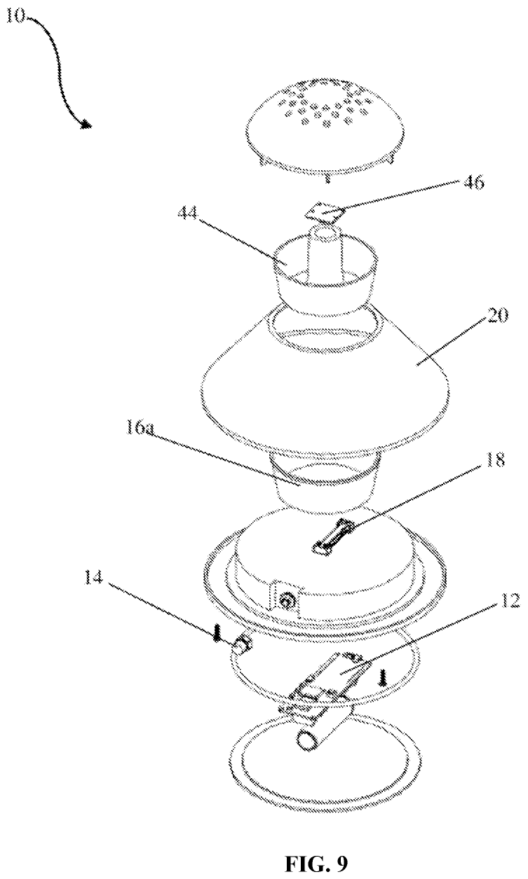

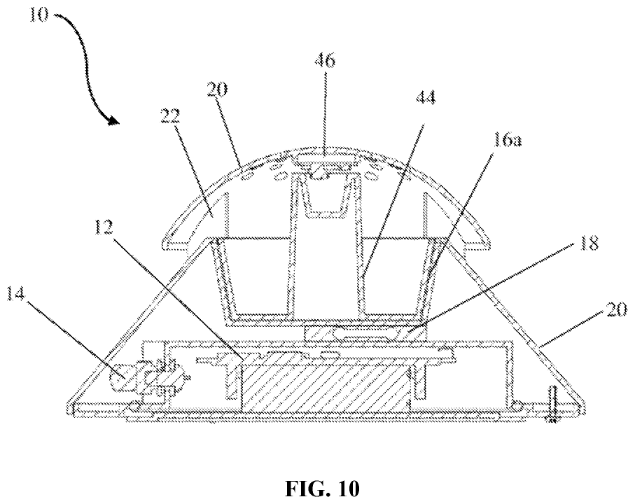

FIGS. 9 and 10 illustrates an example of a remote monitoring device 10 adapted for cockroaches. The remote monitoring device 10 has a housing 20 configured to encapsulate a receptacle 16a and one or more cockroaches. The receptacle 16a is configured to have a layer of adhesive lining 44 that is impregnated with bait or a lure. The housing 20 is configured to a circular opening 22 to assist with trapping the cockroaches within the housing 20. The receptacle 16a is located above an enclosure housing a load cell 18, a microprocessor 12, and a transmitter 14 in the form of a transmission antenna. Additionally, the housing 20 is configured with an optical sensor 46 for detecting the presence of cockroaches. The optical sensor 46 being in communication with a switch to activate or deactivate the load cell 18.

When the optical sensor 46 detects movement, the microprocessor 12 activates the load cell 18 and instructs the load cell 18 to measure an initial mass of the empty receptacle 16a. As the cockroaches crawl through the opening 22 and into the receptacle 16a, they become stuck in the adhesive lining 44 and act as the monitored load. As the number of cockroaches in the receptacle 16a increase, the current mass also increases. Upon the microprocessor 12 determining that a mass difference value is the same or exceeds a predetermined mass difference value, the microprocess 12 will prepare and transmit a notification signal, via the transmitter 14, to a could server for informing the observer/end user. This is advantageous as it allows the observer/end user to know when to retrieve the replenish the adhesive lining and dispose of the cockroach corpses.

In an embodiment, the microprocessor 12 transmits a time stamp associated with the initial mass, a time stamp associated with the current mass when the mass difference value has reached the predetermined mass difference value, and a set of images from the optical sensor 46. This enables the observer/end user to determine population size and the maturity level of the cockroach colony.

### Method of Monitoring Animals or Insects

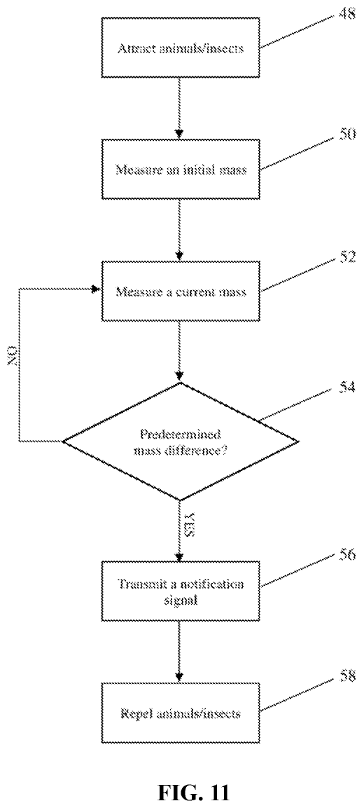

FIG. 11 show a flow diagram of a method for monitoring animals or insects. This method may be implemented by the monitoring device shown in FIGS. 1 to 10.

The method for monitoring animals or insects initially comprises, at step 48, attracting one or more animals or insects to a monitored device 10, in particular to a receptacle 12a for holding a monitored load or a platform 12b for carrying the monitored load. The receptacle/platform 12a, 12b is configured with one or more load cells 18 for enabling the measurement of the monitored load.

At step 50 a microcontroller 12 measures, using the one or more load cells 18, an initial mass of the monitored load. This established a reference point for the accurate recordal of subsequent measurements. At step 52 the microcontroller 12 measures, using the one or more load cells 18, a current mass of the monitored load. The microcontroller 12 subsequently compares the initial mass with the current mass and determines a mass difference value.

At decision point 54, if the microcontroller 12 determines that the mass difference value isn't the same or exceeds a predetermined mass difference value, the microcontroller 12 will measure another current mass in accordance with a predetermined time period. This measuring period may be of any periodic time value, such by way of example every 30 minutes, every 12 hours, or every 24 hours.

When the microcontroller 12 determines that the mass difference is the same or exceeds the predetermined mass difference, at step 56, the microcontroller 12 prepares a notification signal for transmission to an external device. The notification signal is subsequently transmitted with the transmitter 14. It would be appreciated by persons skilled in the art that additional data may be transmitted along with the notification signal, such as recorded mass values and time stamps associated with these recordings.

At step 58, the microcontroller can activate a repellent to repel the animals or insects away from the remote monitoring device 10. This advantageously allows observers to know when the remote monitoring device 10 has been exhausted of consumables or has been filled with trapped insects and requires replenishment or emptying, and that other animals or insects will be driven away so as to not consumer further feed/bait.

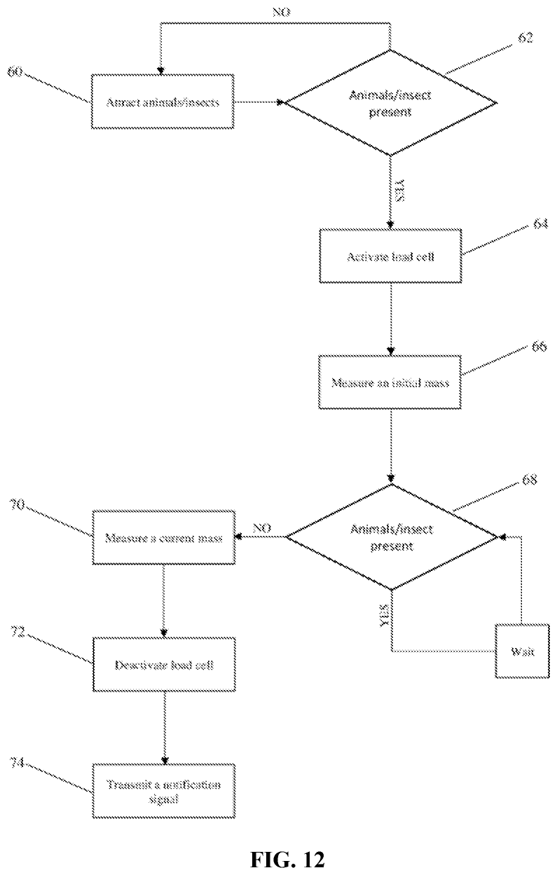

FIG. 12 show a flow diagram of another method for monitoring animals or insects. This method may be implemented by the monitoring device shown in FIGS. 1 to 10.

This method for remote monitoring of animals or insects comprises, at step 60, attracting one or more animals or insects to the remote monitored device 10, in particular to the receptacle/platform 16a, 16b. The receptacle/platform 16a, 16b is configured with one or more load cells 18 for measuring mass as well as a switch for activating/deactivating the one or more load cells 18. The switch is in communication with a sensor for sensing the presence of animals/insects.

At decision point 62, if the sensor registers the presence of animals/insects, it will cause the switch to activate the one or more load cells 18, at step 64, and the microprocessor 12 will start the measurement of the initial mass of the monitored load, at step 66. Otherwise, the switch will lay dormant.

At decision point 68, when the sensor registers the lack of presence of animals/insects, the microprocessor 12 will measure the current mass of the monitored load, at step 70, prior to allowing the switch to deactivate the one or more load cells 18, at step 72. The microcontroller 12 subsequently prepares a notification signal for transmission to an external device using the transmitter at step 74. This advantageously allows observers to know when animals/insects have attended the remote monitoring device 10 and allows for the collection of data of the feeding behaviours of the animals/insects to determine/monitor the general welfare of the animals/insects and local environmental factors that contribute to the behaviours/welfare of the animals/insects.

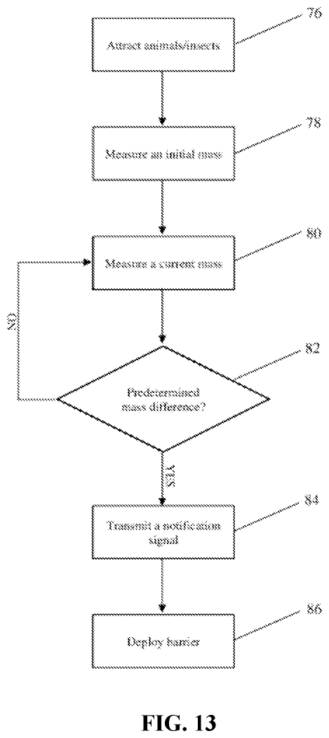

FIG. 13 show a flow diagram of a final method for monitoring animals or insects. This method may be implemented by the monitoring device shown in FIGS. 1, 2, 7, and 8.

This final method for monitoring animals or insects is like the method show in FIG. 11. At step 76, the animals or insects are attracted to the monitored device 10, configured with a housing 20 having one or more openings 22 each having a deployable barrier, to interact with the receptacle/platform 16a, 16b. The animals or insects may access the interior of the housing 20 through the one or more openings 22 to access the receptacle/platform 16a, 16b.

At step 78, the microcontroller 12 measure, using the one or more load cells 18, the initial mass of the monitored load. After the predetermined period of time has lapsed, the microcontroller 12 measures the current mass of the monitored load at step 80. Subsequently, the microcontroller 12 determines the mass difference value by comparing the initial mass with the current mass.

At decision point 82, if the microcontroller 12 determines that the mass difference value is less than the predetermined mass difference value, the microcontroller will loop back to step 80. If the microcontroller 12 determines that the mass difference is the same or more than the predetermined mass difference value, it will prepare the notification signal for transmission to the external device via the transmitter 14 at step 84.

Once the notification signal has been transmitted, the microcontroller 12, at step 86, will transmit a signal to trigger the deployment of each deployable barrier to cover the one or more openings 22. This advantageously allows observers to know when the remote monitoring device 10 has been triggered to deploy the barriers to deny access to the receptacle/platform 16a, 16b or has captured one or more animals or insects for retrieval.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A remote monitoring device for one or more animals or insects, comprising:
a receptacle or platform for receiving a monitored load, the receptacle or platform is configured with one or more load cells for measuring the monitored load; a transmitter; and
a microcontroller configured with a processor; wherein the processor is programmed to:
measure, with the one or more load cells, an initial mass of the monitored load;
periodically measure, with the one or more load cells, a current mass of the monitored load; and
transmit, with the transmitter, a notification signal once a predetermined mass difference between the initial mass and the current mass is reached.

2. The device of claim 1, further comprising a switch configured to enable or disable the one or more load cells.

3. The device of claim 2, wherein the switch is further configured as a manually activated switch.

4. The device of claim 2, wherein the switch is in communication with a sensor, and the switch being further configured to enable or disable the one or more load cells based upon an input from the sensor.

5. A remote monitoring device for one or more animals or insects, comprising:
a receptacle or platform for receiving a monitored load, the receptacle or platform is configured with one or more load cells for measuring the monitored load;
a switch, in communication with a sensor, configured to enable or disable the one or more load cells;
a transmitter; and
a microcontroller configured with a processor; wherein the processor is programmed to:
activate, with the switch, the one or more load cells when the switch receives an input from the sensor;
measure, with the one or more load cells, an initial mass of the monitored load;
deactivate, with the switch, the one or more load cells when the switch receives another input from the sensor;
measure, with the one or more load cells, a current mass of the monitored load; and
transmit, with the transmitter, a notification signal containing a mass difference between the initial mass and the current mass.

6. The device of claim 5, wherein the sensor is an audio, motion, optical, thermal, vibration, or video sensor.

7. The device of claim 5, wherein the sensor is a strain gauge or another load cell incorporated in another ramp or platform for supporting the one or more animals.

8. The device of claim 5, wherein the measurable load is an edible substance.

9. The device of claim 5, wherein the measurable load is the one or more insects.

10. The device of claim 9, wherein the receptacle or platform is configured with an adhesive surface for trapping the one or more insects.

11. The device of claim 5, further comprising a housing for the receptacle or platform, wherein the housing comprises at least one opening for enabling access to the receptacle or platform for the one or more animals or insects.

12. The device of claim 11, wherein each of the at least one opening has a deployable barrier for blocking the opening.

13. The device of claim 12, wherein each deployable barrier may be deployed upon receiving an input from a trigger sensor.

14. The device of claim 12, wherein the deployable barrier may be deployed when the processor transmits the notification signal.

15. The device of claim 5, further comprising a repellent for repelling the one or more animals or insects, wherein the repellent is configured to activate when the processor transmits the notification signal.

16. A method of remote monitoring of animals or insects, comprising:
attracting one or more animals or insects to a receptacle or platform, configured with one or more load cells, for measuring a monitored load;
measuring, with the one or more load cells, an initial mass of the monitored load;
periodically measuring, with the one or more load cells, a current mass of the monitored load; and
transmitting, with a transmitter, a notification signal when a predetermined mass difference between the initial mass and the current mass is reached.

17. The method of claim 16, further comprising repelling, with a repellent, the one or more animals or insects from the receptacle or platform.

18-20. (canceled)
